(19) United States
(12) Patent Application Publication
(10) Pub. No.: US 2024/0343511 A1
(43) Pub. Date: Oct. 17, 2024

(54) MEDIA FEEDING DEVICE AND IMAGE FORMING APPARATUS

(71) Applicant: Yuusuke Masu, Kanagawa (JP)

(72) Inventor: Yuusuke Masu, Kanagawa (JP)

(73) Assignee: Ricoh Company, Ltd., Tokyo (JP)

(21) Appl. No.: 18/634,060

(22) Filed: Apr. 12, 2024

(30) Foreign Application Priority Data
Apr. 17, 2023 (JP) 2023-067399
Jan. 12, 2024 (JP) 2024-003531

(51) Int. Cl. B65H 3/28; B41J 11/00; B41J 13/00; B41J 13/03; B65H 7/12; G03G 15/00

(52) U.S. Cl. CPC B65H 3/28; B41J 11/0095; B41J 13/0018; B41J 13/03; B65H 7/12; G03G 15/50; G03G 15/6511

(57) ABSTRACT

A media feeding device of separating stacked sheet media and feeding the media separately includes end aligners and rotators. The end aligners are disposed opposite each other in a direction intersecting with a feeding direction of the media and contact or separate from both side ends of the media in the direction intersecting with the feeding direction of the media. The rotators are disposed on the end aligners, each of the rotators to rotate around a rotation shaft with a height direction of the end aligners being an axial direction of the rotation shaft, and rotate, in a state in which the end aligners contact the media, to intermittently press parts of the side ends of the media.

### CROSS-REFERENCE TO RELATED APPLICATIONS

This patent application is based on and claims priority pursuant to 35 U.S.C. § 119 (a) to Japanese Patent Application Nos. 2023-067399, filed on Apr. 17, 2023, and 2024-003531, filed on Jan. 12, 2024 in the Japan Patent Office, the entire disclosure of which is hereby incorporated by reference herein.

### BACKGROUND

### Technical Field

Embodiments of the present disclosure relate to a media feeding device and an image forming apparatus.

### Related Art

A media feeding device is known that sequentially separates and feeds stacked sheet media from the top. The media feeding device is a device that provides a function of feeding a medium to an image forming apparatus that forms an image on the medium and that is united with the image forming apparatus. In a case where the sheet feeding device is united with the image forming apparatus, the media feeding device is often disposed at the bottom of the image forming apparatus.

### SUMMARY

In an embodiment of the present disclosure, a media feeding device of separating stacked sheet media and feeding the media separately includes end aligners and rotators. The end aligners are disposed opposite each other in a direction intersecting with a feeding direction of the media and contact or separate from both side ends of the media in the direction intersecting with the feeding direction of the media. The rotators are disposed on the end aligners, each of the rotators to rotate around a rotation shaft with a height direction of the end aligners being an axial direction of the rotation shaft, and rotate, in a state in which the end aligners contact the media, to intermittently press parts of the side ends of the media.

In another embodiment of the present disclosure, there is provided an image forming apparatus that includes an image forming device to form an image on a medium and a media feeder to stack and store sheet media to be fed toward the image forming device. The media feeder is the media feeding device.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a diagram illustrating an overall configuration of an image forming apparatus according to an embodiment of the present disclosure;

FIG. 2 is a plan view of a sheet tray included in a media feeding device;

FIG. 3 is a front view of the sheet tray included in the media feeding device;

FIGS. 4A and 4B are plan views of the sheet tray included in the media feeding device;

FIGS. 5A and 5B are left side views of the sheet tray included in the media feeding device;

FIG. 6 is a diagram illustrating a rotator included in the sheet tray, according to another embodiment of the present disclosure;

FIG. 7 is a diagram illustrating a rotator included in the sheet tray, according to another embodiment of the present disclosure;

FIG. 8 is a diagram illustrating a rotator included in the sheet tray, according to another embodiment of the present disclosure;

FIGS. 9A and 9B are diagrams illustrating an inconvenience of a rotator included in the sheet tray, according to another embodiment of the present disclosure;

FIG. 10 is a diagram illustrating handling when a medium has stopped straddling the sheet tray and a body of an image forming apparatus;

FIG. 11 is a diagram illustrating a rotator included in the sheet tray, according to another embodiment of the present disclosure; and

FIG. 12 is a diagram illustrating an example of a configuration of a control block included in a media feeding device.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

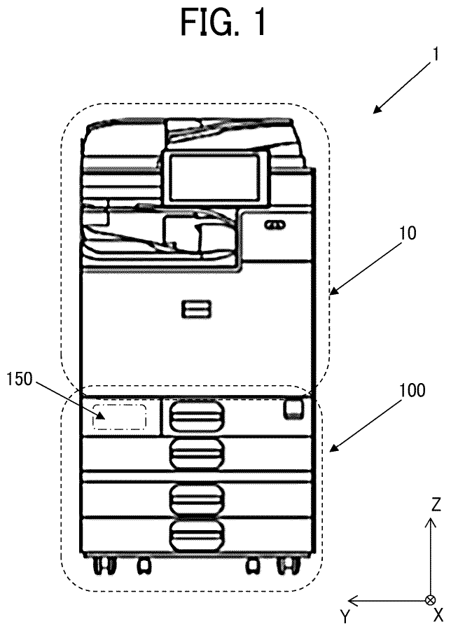

A description is provided of an image forming apparatus according to an embodiment of the present disclosure with reference to drawings. FIG. 1 is a diagram illustrating an overall configuration of a multifunction peripheral (MFP) 1 as an image forming apparatus according to an embodiment of the present disclosure. The MFP 1 has a function of forming an image on a sheet P as an example of a sheet medium. As illustrated in FIG. 1, the MFP 1 includes an image forming device 10 and a sheet tray unit 100 serving as a media feeding device that feeds the sheet P to the image forming device 10.

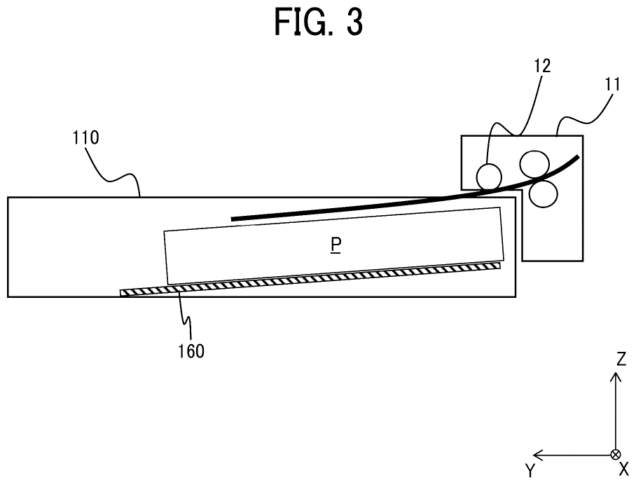

The image forming device 10 forms an image on the sheet P, and ejects the sheet P on which the image has been formed. The image forming device 10 includes a conveying device 11 that picks up a sheet P from the sheet tray unit 100 serving as a media feeder to stack and store sheets P and conveys the sheet P (see FIG. 3). The sheet P conveyed by the conveying device 11 moves to an image forming position of the image forming device 10, and an image is formed on the sheet P. A plurality of methods for performing image formation processing in the image forming device 10 are known, and for example, an inkjet method of forming an image using ink and an electrophotographic method of forming an image using toner are known. A sheet feeding device according to an embodiment of the present disclosure is applicable to any image forming method. Since the image forming device 10 has a typical configuration, a detailed description of the configuration and functions of the image forming device 10 are omitted.

The sheet tray unit 100 includes a plurality of stages of sheet trays 110. Each of the plurality of sheet trays 110 constituting the sheet tray unit 100 store sheets P of various sizes. The characteristics of the sheet tray unit 100 to be described below do not depend on the size of the sheets P to be stored.

### First Embodiment

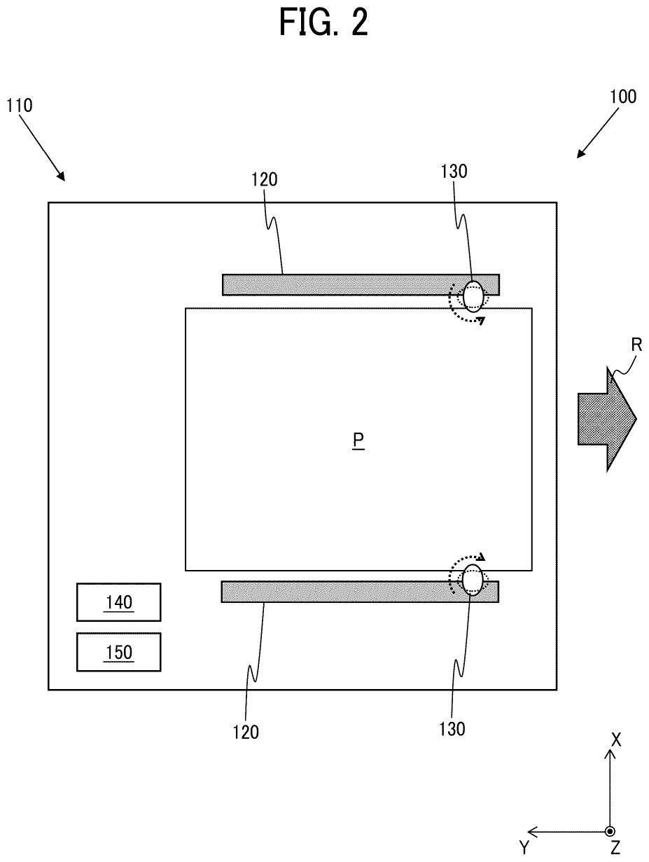

A description is given of the sheet tray unit 100 as a sheet feeding device according to an embodiment of the present disclosure with reference to FIGS. 2 and 3. FIG. 2 is a plan view of the sheet tray 110 included in the sheet tray unit 100. FIG. 3 is a front view of the sheet tray 110. For convenience of explanation, a direction of the Y axis is a feeding direction of the sheet P, that is, a so-called conveyance direction.

The sheet tray 110 includes a bottom plate 160 as a plate member on which sheets P are stacked. The bottom plate 160 is biased upward (in a Z direction). When the sheets P stacked on the bottom plate 160 are fed in the conveyance direction (the direction indicated by an arrow R in FIG. 2), the amount of the sheets P stacked on the bottom plate 160 decreases. As a result, the load of the sheets P on the bottom plate 160 decreases. At this time, the biasing of the bottom plate 160 increases an angle that the bottom plate 160 forms with the horizontal. With such a configuration, the uppermost sheet P of the stacked sheets P reaches a specified position (a feeding start position) regardless of the remaining amount of the stack. The feeding start position corresponds to a position at which a sheet feed roller 12 of the conveying device 11 can contact the uppermost sheet P.

A pair of side fences 120 are arranged facing to each other on both sides of the sheet P in a width direction of the sheet P. The width direction of the sheet P refers to a direction intersecting (orthogonal to) the conveyance direction of the sheet P (the direction indicated by the arrow R in FIG. 2 and corresponds to the feeding direction of the sheet P) and a direction being parallel to a surface of the sheet P.

The side fences 120 also function as an end aligner that aligns ends of the sheets Pin the width direction. When one of the side fences 120 is moved in the width direction, the opposite side fence also moves in the width direction. At this time, the side fences 120 that face each other move in the directions opposite to each other. In other words, the side fences 120 move to contact or separate from both lateral ends of the sheet P to align the ends.

The side fence 120 includes a separation accelerator 130 serving as a rotator at a portion of a contact surface that contacts the sheet P. The separation accelerator 130 has, for example, a spiral groove 132 on an outer circumferential surface of the separation accelerator 130. The separation accelerator 130 is rotated by a rotation shaft 131 whose axial direction is a height direction (Z direction) of the sheet P.

As illustrated in FIG. 2, the separation accelerator 130 is disposed in the vicinity of an end of the side fence 120. Since the side fences 120 form a pair, the separation accelerators 130 are also disposed in a pair. Each of the separation accelerators 130 is disposed near an end of the side fence 120 in the feeding direction of the sheet P, that is, near a front end of the side fence 120. The vicinity of the end of the side fence 120 in the feeding direction of the sheet P is at least on a front side relative to an intermediate position of the side fence 120 in the conveyance direction (feeding direction) of the sheet P.

The sheet tray unit 100 includes a driver 140 that rotates the separation accelerator 130 serving as a rotator and a controller 150 serving as circuitry that controls an operation of the separation accelerator 130 via the driver 140. The operation control of the motor includes, for example, rotation speed control and rotation direction control of the motor. The motor applicable to the sheet tray unit 100 is not limited to any particular form or control method thereof, but may be, for example, a direct current (DC) motor or a brushless motor as long as the motor achieves the operation of the separation accelerator 130 as to be described below.

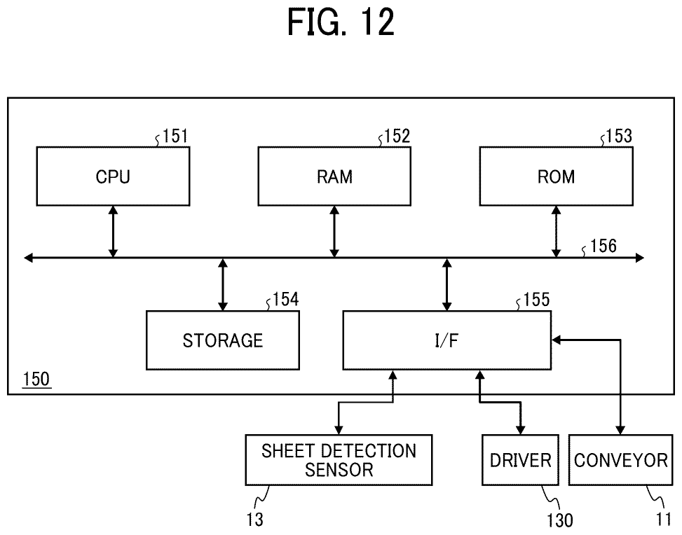

A description is given of a configuration of the controller 150 with reference to FIG. 12. As illustrated in FIG. 12, the controller 150 has a configuration similar to the configuration of an information processing terminal such as a general server or a personal computer (PC).

In the controller 150, a central processing unit (CPU) 151, a random-access memory (RAM) 152, a read-only memory (ROM) 153, a storage 154, and an interface (I/F) 155 are connected to each other via a bus 156. The CPU 151 is an arithmetic device and controls the operation of the entire media feeding device.

The RAM 152 is a volatile storage medium that allows data to be read and written at high speed. When the CPU 151 processes data, the RAM 152 is used as a working area of the CPU 151.

The ROM 153 is a read-only non-volatile storage medium and stores programs such as firmware.

The storage 154 is a non-volatile storage medium that allows data to be read and written, and that stores, for example, an operating system (OS), various control programs, and application programs. The storage 154 is, for example, a solid state drive (SSD) and a hard disk drive (HDD).

The I/F 155 connects the bus 156 to various hardware components or networks for control. The driver 140 is connected to the controller 150 via the I/F 155. The operation of the driver 140 is controlled based on a control program executed using the arithmetic processing function of the CPU 151. The driver 140 includes, for example, a drive transmission mechanism such as an electric motor that supplies driving force to rotate the separation accelerator 130 and a gear that rotates by the rotation of the electric motor.

The controller 150 controls the operation of the driver 140 to operate the separation accelerator 130 on the basis of a signal from a position for detecting whether the sheet P can be fed from the sheet tray 110 or the sheet tray 110 is moved to a position for replenishing the sheet P, and a signal from a sensor serving as a media detector for detecting that the feeding of the sheet P is abnormal.

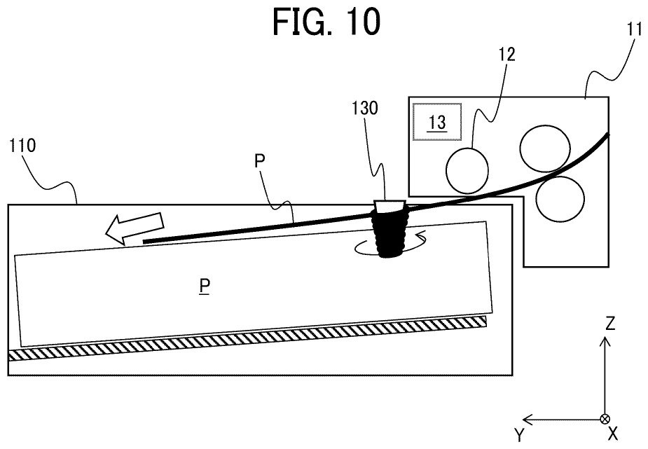

A sheet detection sensor 13 illustrated in FIG. 10 is an example of a media detector that detects that the sheet P is stopped in a state of being moved from the stored position in the feeding direction. The sheet detection sensor 13 is also communicatively connected to the controller 150 via the I/F 155.

The conveying device 11 that conveys the sheet P to the image forming device 10 is disposed in the vicinity of an end of the sheet tray 110 in the feeding direction of the sheet P. The conveying device 11 includes the sheet feed roller 12 that picks up the uppermost one of the sheets P stacked on the sheet tray 110 and moves the sheet P downstream from the sheet tray 110. It is important that the stacked sheets P are separated one by one, and in particular, the uppermost sheet P is separated so that the uppermost sheet P is moved in the feeding direction by the sheet feed roller 12.

As illustrated in FIG. 12, the conveying device 11 is also connected to the controller 150 via the I/F 155. In other words, the operation of the conveying device 11 is also controlled by the controller 150.

As to be described below, the sheet tray unit 100 according to the present embodiment separates the sheets P one by one by operation of the separation accelerator 130. For example, in a case where the processing accuracy of an end of the sheet P is low and there is a burr on the end, a plurality of sheets P may be integrated due to the burr. As a result, when the sheets P are picked up by the sheet feed roller 12, the plurality of sheets P may be picked up at once. To avoid such a state (a state in which the reliability of separation and feeding is decreased), the separation accelerator 130 is rotated to separate the sheets P one by one.

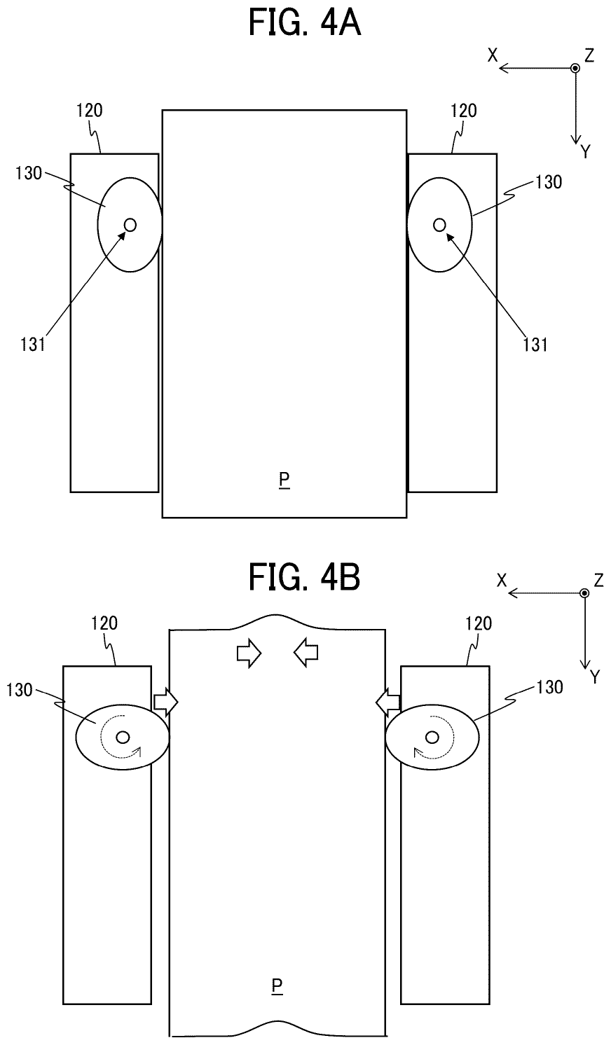

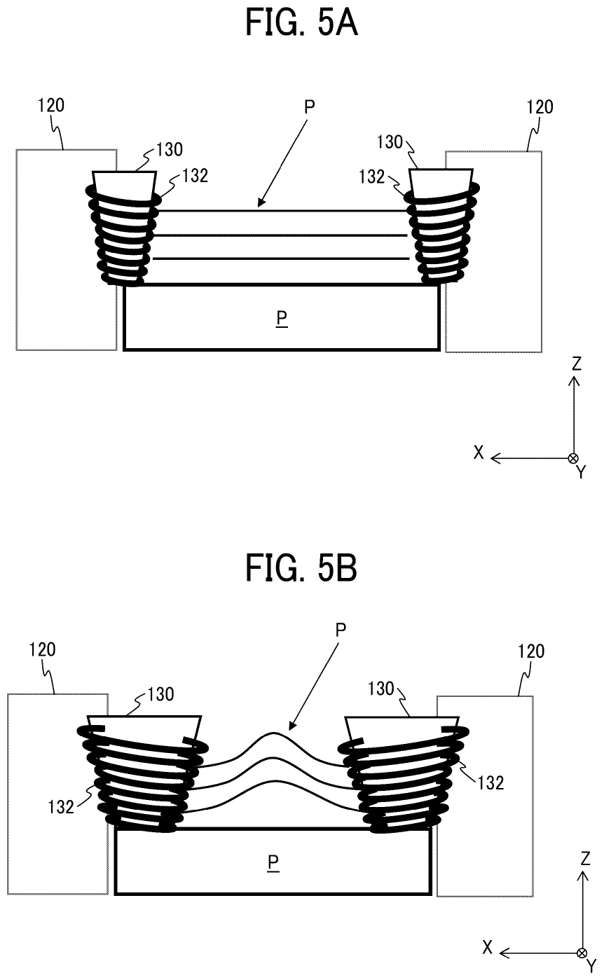

FIGS. 4A and 4B are plan views of the separation accelerators 130 viewed from the axial direction of the rotation shaft 131 (Z direction). FIGS. 5A and 5B are schematic views of the sheet tray 110 including the separation accelerators 130 viewed from a downstream side in the feeding direction of the sheet P (viewed from the right side in FIG. 2).

As illustrated in FIGS. 4A and 4B, the separation accelerator 130 has an elliptical shape in a plan view, in which the distance from the rotation shaft 131 to the outer circumferential surface of the separation accelerator 130 is not uniform and in which a relative relationship between the outer circumferential surface of the separation accelerator 130 and the sheet P changes periodically by rotation. Accordingly, in the state illustrated in FIG. 4A, the outer circumferential surface of each of the separation accelerators 130 contacts a side end of the sheet P but does not press the side end toward the center in the width direction. On the other hand, in the state illustrated in FIG. 4B, the outer circumferential surface of each of the separation accelerators 130 contacts a side end of the sheet P and presses the sheet P toward the center in the width direction.

As illustrated in FIGS. 5A and 5B, the separation accelerator 130 has a spiral groove 132 on the outer circumferential surface of the separation accelerator 130. As illustrated in FIG. 5A, in a state (load releasing state) where the separation accelerator 130 does not press a side end of the sheet P, the separation accelerator 130 is rotating. As a result, as illustrated in FIG. 5B, the separation accelerator 130 intermittently presses the side end of the sheet P at regular intervals (a pressing state). In other words, due to the rotation of the separation accelerator 130, the pressure acting from the side end toward the central portion is periodically applied to the sheet P, so that the load releasing state and the pressing state are periodically repeated.

The sheet P is caught in the spiral groove 132 formed on the outer circumferential surface of the separation accelerator 130 while the pressing state and the load releasing state are repeated. Due to this catching, a force is applied to the sheet P such that the sheet P moves upward along the spiral groove 132 as the separation accelerator 130 rotates. The separation accelerator 130 has a shape whose outer circumferential surface is shorter toward the lower side, that is, a so-called tapered shape.

As the separation accelerator 130 having the tapered shape rotates, the operation of repeating the load releasing state and the pressing state is performed. As the sheet P moves upward along the spiral groove 132 along with this operation, a force applied to the sheet Pin the pressing state increases. By the repetition of the change of the force, an upper sheet P, which has been in intimate contact with a lower sheet P in a stacked state, is separated from the lower sheet P and facilitated to move in the feeding direction.

### Second Embodiment

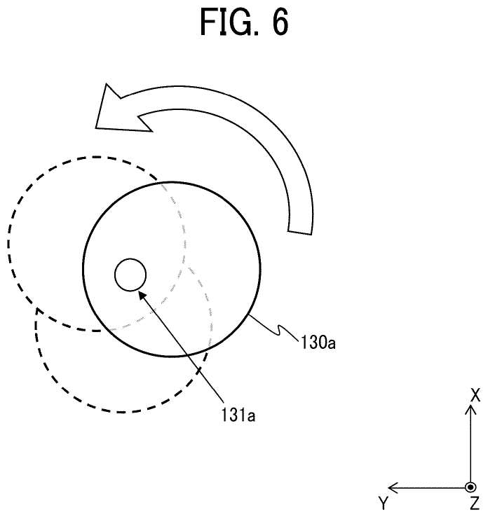

The separation accelerator 130 described in the first embodiment has an elliptical shape in a plan view. However, the shape of the separation accelerator 130 is not limited to this shape. For example, as illustrated in FIG. 6, the shape of a separation accelerator 130a in a plan view may be a circular shape. The separation accelerator 130a may be disposed such that a rotation shaft 131a of the separation accelerator 130a is offset from the center of the circular shape and the rotational center of the separation accelerator 130a is eccentric. The outer circumferential surface of the separation accelerator 130a having the structure described above can periodically presses a side end of the sheet P by rotation. In other words, any structure may be adopted as long as the structure can achieve repetition of the load releasing state and the pressing state by rotation of the separation accelerator 130a.

A spiral groove may also be formed on an outer circumferential surface of the separation accelerator 130a.

### Third Embodiment

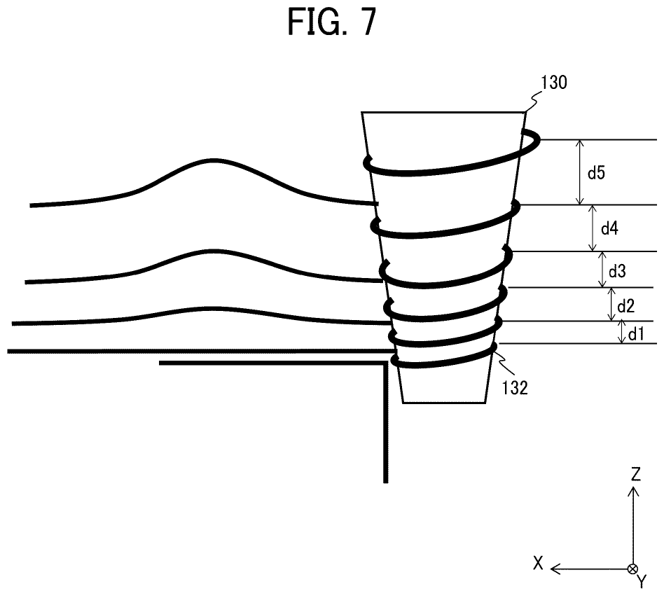

As illustrated in FIG. 7, intervals of the spiral grooves 132 formed in the separation accelerator 130 may not have uniform groove spacing d in the axial direction, but may be formed to be wider from the lower portion to the upper portion in the axial direction. In other words, in a case of the separation accelerator 130 illustrated in FIG. 6, a groove spacing d in the vicinity of the lowest end is defined “d1”, and a groove spacing d in the vicinity of the uppermost end is defined “d5”. In a case where the intermediate groove spacings between the “d1” and “d5” are defined “d2”, “d3”, and “d4” in order from the bottom portion, the spiral groove 132 may be formed to satisfy the relation of “d1<d2<d3<d4<d5”.

Narrowing the lower groove spacing d can prevent a plurality of sheets P from entering one spiral groove 132 when the uppermost one of the stacked sheets P is separated one by one. As a result, the reliability in separation of the sheet P can be enhanced.

When a higher sheet P that has moved to an upper area of the separation accelerator 130 is separated from a lower sheet P to a greater extent, the higher sheet P can be more smoothly moved in the feeding direction. Accordingly, the separation accelerator 130 may be formed such that upper groove spacing d is wider than lower groove spacing d.

### Fourth Embodiment

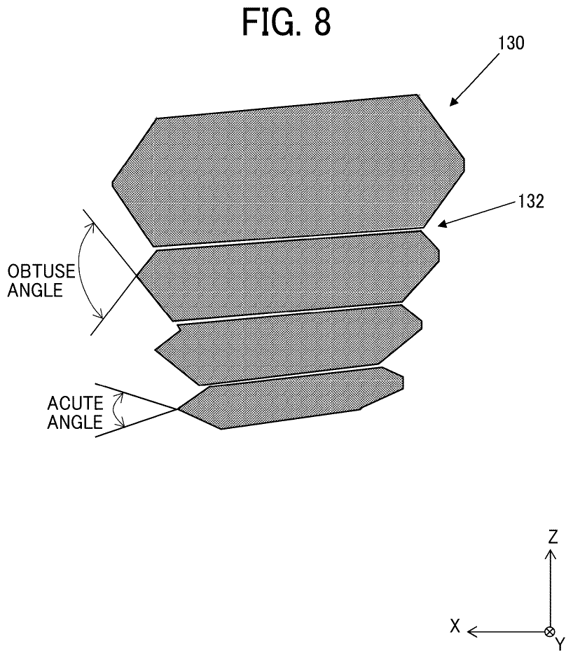

As illustrated in FIG. 8, a groove angle that is a formation angle of the spiral groove 132 formed in the separation accelerator 130 may not be uniform in the axial direction of the separation accelerator 130. The spiral grooves 132 may be formed such that a spiral groove 132 (lower spiral groove 132) closer to the uppermost one of the stacked sheets P has a more acute angle and a spiral groove 132 higher in the separation accelerator 130 has a more obtuse angle. In the following description, the groove angle is referred to as a “spiral taper angle”.

Making the spiral taper angle in the lower spiral groove 132 an acute angle can enhance the reliability in separation of the uppermost one of the stacked sheets P and can enhance the separability of the sheets P. The spiral taper angle may be an obtuse angle for a sheet P having moved to an upper area of the separation accelerator 130 from the viewpoint of considering smoothing of the movement in the feeding direction.

### Fifth Embodiment

When the separation accelerator 130 rotates to repeat the load releasing state and the pressing state to move the stacked sheets P upward, it is preferable that the sheets P are sequentially fed from a sheet P having moved to the uppermost position. In order to enhance the reliability of feeding of the sheet P when the image forming device 10 operates, the execution of the separating operation of the sheet P is required to some extent even at a timing (standby state) when the image forming device 10 does not operate.

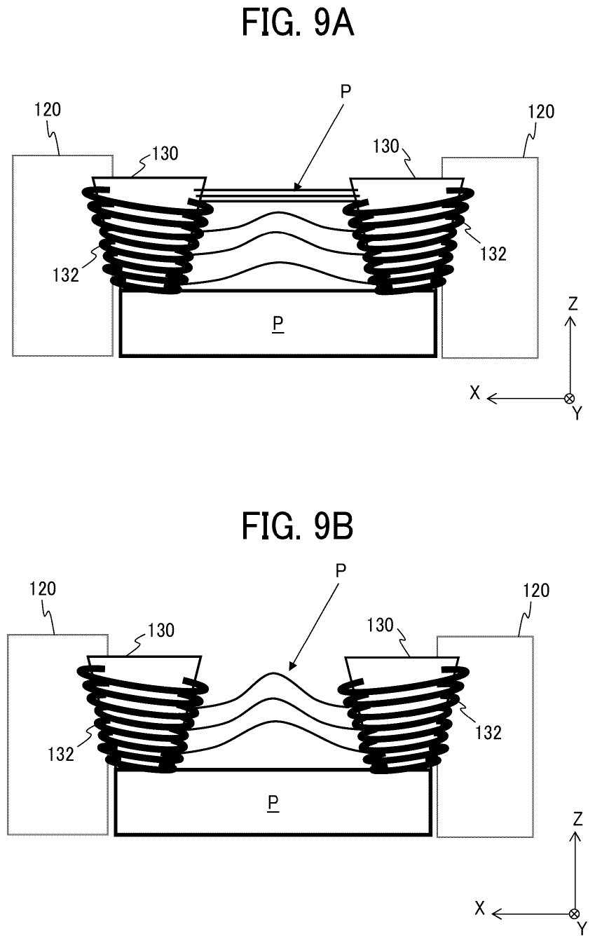

For example, in a case where the feeding speed of the sheet P is slow as compared with the degree to which the uppermost sheet P is separated (the degree of progress of the separation of the uppermost sheet P), a plurality of sheets P may be accumulated in an upper area of the separation accelerators 130 as illustrated in FIG. 9A if the separation accelerators 130 are kept rotating. If such accumulation lasts for a long time, the sheets P may return from the separated state to the closely contacted state. The case where the feeding speed is slow with respect to the degree of progress of the separation of the sheet P includes a case where a feeding standby time of the sheet P is long in the image forming processing.

It is preferable that the controller 150 monitors the status of the feeding operation of the sheet P and adjusts the degree of progress of the separation of the sheet P according to the degree of execution of the feeding operation so that the sheet P is fed without close re-contact. For example, the controller 150 adjusts the rotation speed of the separation accelerator 130 to adjust the degree of progress of the separation. In this case, examples of the adjustment include setting the rotation speed of the separation accelerator 130 to zero, that is, stopping the rotation of the separation accelerator 130.

The controller 150 adjusts the rotation speed of the separation accelerator 130 such that the sheet P is fed in a state of being stuck in the spiral groove 132 (rather than being stagnant). When the feeding operation is not performed at a timing at which the sheet P is about to stay at the uppermost position, the rotation direction of the separation accelerator 130 is reversed, so that the sheet P that has moved to the uppermost position is temporarily moved downward. In other words, when the sheet P may be in a stagnant state at the uppermost position, the controller 150 rotates the separation accelerator 130 in a direction opposite to the rotation direction in which the feeding of the sheet P is normally performed.

In other words, the separation accelerator 130 and the controller 150 according to the present embodiment can appropriately adjust the position of the sheet P in the Z-axis direction in accordance with, for example, the feeding speed of the sheet P or the period of the feeding standby state while separating the uppermost sheet from the stacked sheets P and setting the uppermost sheet in a suppliable state.

### Sixth Embodiment

When stacked sheets P are separated by the operation of the separation accelerator 130 and the feeding of the sheets P by the sheet feed roller 12 is started, a conveyance failure of the sheets P may occur. For example, as illustrated in FIG. 10, it is assumed that a sheet P stops in a state of straddling the sheet tray 110 and the conveying device 11. In this case, even if the sheet tray 110 is removed in order to remove the sheet P whose conveyance has been stopped, the sheet P becomes an obstacle.

When the sheet detection sensor 13 included in the conveying device 11 detects the sheet P, as illustrated in FIG. 10, the controller 150 determines that the sheet P is at a straddling position at which the sheet P has been partially moved in the feeding direction from the storage position. When this state continues for a certain time, the controller 150 determines that the conveyance of the sheet P is stopped and the sheet P is left at the straddling position at which the sheet P has been partially moved in the feeding direction from the storage position.

At this time, the controller 150 rotates the separation accelerator 130 in a direction opposite to the rotation direction of the separation operation. When the separation accelerator 130 is reversed, the degree of pressing of the separation accelerator 130 is weakened while the sheet P moves downward along the spiral groove 132, and thus the sheet P moves in a direction in which the sheet P returns to the sheet tray 110.

In other words, the sheet P that has been stopped straddling between the sheet tray 110 and the conveying device 11 can be returned to the sheet tray 110.

### Seventh Embodiment

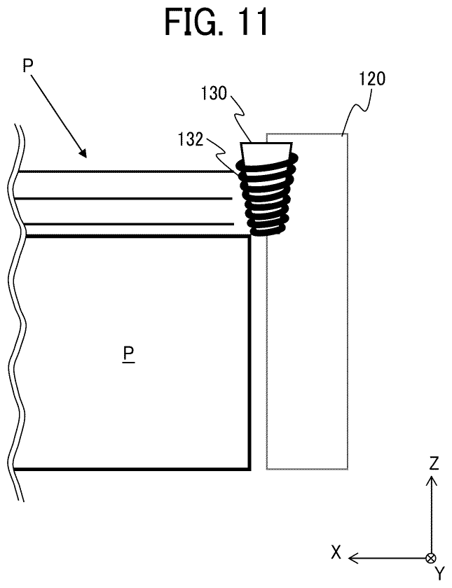

As illustrated in FIG. 11, the separation accelerator 130 may be disposed in the vicinity of the upper end of the side fence 120 in the height direction. The number of sheets P on which the separation accelerator 130 performs pressing and load releasing may be within about upper ten sheets of the sheets P stacked on the sheet tray 110. Accordingly, a range in which the separation action by the separation accelerator 130 is to be provided is assumed to be a certain range of upper sheets of the stacked sheets P. The separation accelerator 130 may be installed at a position and in a size such that the separation accelerator 130 contacts the sheets P placed in the fixed range. As a result, the size of the separation accelerator 130 can be reduced.

Embodiments of the present disclosure are not limited to the above-described embodiments and modifications, and numerous additional modifications and variations are possible in light of the teachings. The technical contents included in the technical ideas described in the appended claims are included within the technical scope of the appended claims. The above-described embodiments and modifications are some examples, and various modifications and variations can be practiced from such examples by those skilled in the art. Such modifications and variations are included in the technical scope described in the appended claims.

In other words, the media feeding device is described as a sheet tray unit of an image forming apparatus in each of the embodiments described above. However, the media feeding device may be a sheet feeding device externally attached to an image forming apparatus.

The above-described embodiments illustrate the configuration in which the sheet tray unit 100 includes the controller 150. However, embodiments of the present disclosure are not limited to this, and a configuration equivalent to the controller 150 may be implemented by a control configuration that controls the entire image forming apparatus.

Aspects of the present disclosure are, for example, as follows.

### First Aspect

A media feeding device (e.g., the sheet tray unit 100) that separates stacked sheet media (e.g., the sheets P) and feeds the media separately includes end aligners (e.g., the side fences 120) and rotators (e.g., the separation accelerators 130). The end aligners are disposed opposite each other in a direction intersecting with a feeding direction of the media, and contact or separate from both side ends of the media in the direction intersecting with a feeding direction of the media. The rotators are disposed on the end aligners and rotate around a rotation shaft (e.g., the rotation shaft 131) with a height direction of the end aligners being an axial direction of the rotation shaft (e.g., the rotation shaft 131). The rotators rotate, in a state in which the end aligners contact the media, to intermittently press parts of the side ends of the media.

### Second Aspect

In the media feeding device (e.g., the sheet tray unit 100) according to the first aspect, the rotators (e.g., the separation accelerators 130) are disposed adjacent to a leading end of the stacked sheet media in the feeding direction of the media (e.g., the sheets P).

### Third Aspect

In the media feeding device (e.g., the sheet tray unit 100) according to the first or second aspect, each of the rotators (e.g., the separation accelerators 130) has an elliptical shape in a direction orthogonal to the axial direction of the rotation shaft (e.g., the rotation shaft 131).

### Fourth Aspect

In the media feeding device (e.g., the sheet tray unit 100) according to the first or second aspect, each of the rotators (e.g., the separation accelerators 130) has a circular shape in a direction orthogonal to the axial direction of the rotation shaft (e.g., the rotation shaft 131), and the rotation shaft is eccentric.

### Fifth Aspect

In the media feeding device (e.g., the sheet tray unit 100) according to any one of the first to fourth aspects, each of the rotators (e.g., the separation accelerators 130) has a contact surface to contact the media (e.g., the sheets P), and the contact surface has a spiral groove (e.g., the spiral groove 132).

### Sixth Aspect

In the media feeding device (e.g., the sheet tray unit 100) according to the fifth aspect, groove spacing of the spiral groove (e.g., the spiral groove 132) is wider from a lower portion to an upper portion in the height direction of the end aligners (e.g., the side fences 120).

### Seventh Aspect

In the media feeding device (e.g., the sheet tray unit 100) according to the fifth or sixth aspect, a groove angle of the spiral groove (e.g., the spiral groove 132) is more acute from an upper portion to a lower portion in the height direction of the end aligners (e.g., the side fences 120).

### Eighth Aspect

In the media feeding device (e.g., the sheet tray unit 100) according to any one of the first to sixth aspects, each of the rotators (e.g., the separation accelerators 130) is tapered from an upper portion to a lower portion in the height direction of the end aligners (e.g., the side fences 120).

### Ninth Aspect

The sheet feeding device (e.g., the sheet tray unit 100) according to any one of the first to eighth aspects further includes a controller (e.g., the controller 150) that controls a rotation speed of the rotators (e.g., the separation accelerators 130) in accordance with a feeding speed of the media (e.g., the sheets P).

### Tenth Aspect

The media feeding device (e.g., the sheet tray unit 100) according to the ninth aspect further includes a media detector (e.g., the sheet detection sensor 13) to detect that a medium of the media (e.g., the sheets P) has stopped in a state in which the medium has moved in the feeding direction from a storage position of the media. The controller (e.g., the controller 150) rotates the rotators (e.g., the separation accelerators 130) in reverse when the controller detects stop of the medium with the media detector.

### Eleventh Aspect

An image forming apparatus (e.g., the MFP 1) includes an image forming device (e.g., the image forming device 10) that forms an image on a medium (e.g., the sheet P) and a media feeder (e.g., the sheet tray unit 100) to stack and store sheet media to be fed toward the image forming device. The media feeder is the media feeding device (e.g., the sheet tray unit 100) according to any one of the first to tenth aspects.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

The functionality of the elements disclosed herein may be implemented using circuitry or processing circuitry which includes general purpose processors, special purpose processors, integrated circuits, application specific integrated circuits (ASICs), digital signal processors (DSPs), field programmable gate arrays (FPGAs), conventional circuitry and/or combinations thereof which are configured or programmed to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein or otherwise known which is programmed or configured to carry out the recited functionality. When the hardware is a processor which may be considered a type of circuitry, the circuitry, means, or units are a combination of hardware and software, the software being used to configure the hardware and/or processor.

1. A media feeding device of separating stacked sheet media and feeding the media separately, the media feeding device comprising:
end aligners disposed opposite each other in a direction intersecting with a feeding direction of the media, the end aligners to contact or separate from both side ends of the media in the direction intersecting with the feeding direction of the media; and
rotators disposed on the end aligners, each of the rotators to rotate around a rotation shaft with a height direction of the end aligners being an axial direction of the rotation shaft,
the rotators to rotate, in a state in which the end aligners contact the media, to intermittently press parts of the side ends of the media.

2. The media feeding device according to claim 1,
wherein the rotators are disposed adjacent to a leading end of the stacked sheet media in the feeding direction of the media.

3. The media feeding device according to claim 1,
wherein each of the rotators has an elliptical shape in a direction orthogonal to the axial direction of the rotation shaft.

4. The media feeding device according to claim 1,
wherein each of the rotators has a circular shape in a direction orthogonal to the axial direction of the rotation shaft and the rotation shaft is eccentric.

5. The media feeding device according to claim 1,
wherein each of the rotators has a contact surface to contact the media, and the contact surface has a spiral groove.

6. The media feeding device according to claim 5,
wherein groove spacing of the spiral groove is wider from a lower portion to an upper portion in the height direction of the end aligners.

7. The media feeding device according to claim 5,
wherein a groove angle of the spiral groove is more acute from an upper portion to a lower portion in the height direction of the end aligners.

8. The media feeding device according to claim 1,
wherein each of the rotators is tapered from an upper portion to a lower portion in the height direction of the end aligners.

9. The media feeding device according to claim 1, further comprising circuitry configured to control a rotation speed of the rotators in accordance with a feeding speed of the media.

10. The media feeding device according to claim 9, further comprising a media detector to detect that a medium of the media has stopped in a state in which the medium has moved in the feeding direction from a storage position of the media,
wherein the circuitry is configured to rotate the rotators in reverse when the circuitry detects stop of the medium with the media detector.

11. An image forming apparatus comprising:
an image forming device to form an image on a medium; and
a media feeder to stack and store sheet media to be fed toward the image forming device,
wherein the media feeder is the media feeding device according to claim 1.
